(19) United States
(12) Patent Application Publication
(10) Pub. No.: US 2005/0272496 A1
(43) Pub. Date: Dec. 8, 2005

(54) Automated game system for use on golf driving ranges and in other arena-based sports

(76) Inventors: Israel Bennett Reinish, Boulder, CO (US); Jeffrey Michael Buske, Boulder, CO (US)

Correspondence Address: Richard S. Missimer, 2218 S Sanctuary Drive, New Berlin, WI, 53151, US

(21) Appl. No.: 10/860,222

(22) Filed: Jun. 3, 2004

(51) Int. Cl. G06F 17/00; G06F 19/00

(52) U.S. Cl. 463/2

(57) ABSTRACT

A game system that converts golf ranges, practice cages and fields, and sports arenas into a competitive and entertaining group activity, improving the players skills of the game while making it more fun to do so. The system comprises a game engine or computer, a plurality of targets, sound reinforcement, and an optional scoreboard. The optional scoreboard, much like those used in baseball or football, provides mass communications of ongoing scores and time remaining. The sound reinforcement provides a parallel form of the same of similar information and the sound effects associated with target impact and game success. These elements can be connected together by wire, or wireless means. This combination allows for the teaching and support of the games by means of sound and visual communications, which provides the player with all the instructions, game status and rewards.

### CROSS REFERENCE TO RELATED APPLICATION

These inventors claim priority from a U.S. Provisional patent application No. 32,267 filed Jun. 6, 2003 docket # RM618.

### FIELD OF THE INVENTION

The present invention relates to the field of sports entertainment. More specifically, it relates to a game system for use at golf driving ranges, and potentially in batting cages or arena based sports. The invention is designed to introduce a new golf related pastime, to enhance golf driving ranges by offering golfers (and would-be golfers) the opportunity to play and compete rather than just practice their skill. The system can be adapted to others sports such as hockey, soccer, baseball, and the like.

### RELATED ART

U.S. Pat. No. 5,439,224 to Bertoncino (1995) uses Universal Product Code (UPC) codes on balls for identification, provides no immediate feedback, and provides for printout from computer in office.

Pub. No. US 2002/0065567 A1 (Kodera) published May 30, 2002 uses the generic term “ID number” to describe how a ball is associated with a particular player, and LCDs in each hitting bay.

Intl. Pub. No. PCT WO 02/4011 A1 published May 23, 2002 discloses a large target built into the ground.

U.S. Pat. No. 6,569,028 issued to Nichols, et al. (2003) discloses targets with a detection subsystem and a golf ball dispensing subsystem

Intl. Pub. No. PCT WO 02/41240 A1 published May 23, 2002 discloses a device for reading coded golf balls.

Intl. Pub. No. PCT WO 99/48046 published Sep. 23, 1999 discloses golf balls incorporating uniquely-coded passive transponders and a RFID device to read them.

U.S. Pat. No. 3,104,879 to Jetton (1963) discloses targets that simulate greens with cups built into landing area to support improved practice and game playing options.

### BACKGROUND OF THE INVENTION

The golf industry currently has millions of people that try the game with an equal number that give it up each year. The industry continues to have problems attracting and keeping people. There are four (4) reasons that have been identified for this lack of continued interest.

These issues are: cost, the availability of time and playing partners, and a need for continual improvement of the skills required in the game itself. The costs vary but with greens and cart fees can be a significant obstacle for some potential golfers. It can take between 4-6 hours to play a round of golf which can overwhelm someone with limited interest Having a group of friends that you consistently play with in a foursome is one of the most powerful factors influencing the play of avid golfers, but perhaps the greatest obstacle to attracting and keeping new players to the game is the issue of skills development. Golf is not a difficult game conceptually, but it requires a considerable amount of hand-eye coordination to consistently strike the ball well. The game is not much fun until that skill is developed. Potential golfers face three alternatives in order to achieve the desired skill set. They can 1) continue play, while trying to develop their ball striking skills, 2) spend many frustrating and boring hours at a practice range, or 3) just give up.

The current invention was designed to address all of these obstacles. This system (and the games it facilitates), can aid the golfer in improving their skill level while playing a variety of games, all within one-half hour. The cost is substantially less than a round of golf. These games are designed to encourage group play. The games teach good ball striking skills emphasizing accuracy instead of power. The result of which is an overall improvement in the skills required to be an avid golfer, without the boredom, pain and embarrassment associated with the alternatives.

### DESCRIPTION OF THE RELATED ART

For the most part, golf-driving ranges are thought of as practice areas for players seeking to develop or enhance a set of skills. They consist of large tracts of land where a golfer can go and hit balls into an open area. Most driving ranges have some sort of visible or physical demarcations strategically placed about the landing area of the range, which indicate various distances from the tee area, which provides a reference point and target for the golfer. These demarcations can include anything from a flag on the end of a pole, to a mound of dirt covered in grass designed to look like a green one would find on a golf course.

Some driving ranges provide discernable targets, for golfers to aim at, that are visibly pleasing. Such targets can take just about any form, from large painted bulls eyes, to “baskets” made of netting material, to molded plastic that illuminate and make sounds when hit, to placards cut to just about any shape imaginable. The purpose of such targets is similar to the demarcations mentioned above but can make the golfer's experience more fun and playful, and can potentially facilitate game playing. The invention of the game, more often than not, is left to the imagination of the players to create for themselves. In the alternative, there are games, which have been pre-designed as seen by the prior art. Such games are promoted and supported by a printed scorecard given to players to track their scores and potentially compete with other players.

In a very few cases, have these targets been combined with automated systems to complete the gaming experience by making the tracking of a player's actions automatic. In such systems, balls are collected in the targets and then identified, enabling the automatic tracking system to discern which golfer hit a particular ball. This information, describing which target was hit by which player, is input into a computerized scoring or gaming system which dictates the progression of the game and communicates to the player through a video monitor (located at each tee) their outcome or status. Such a system is very costly, needs repeated maintenance due to the proximity of the golfer to the individual displays, and makes it necessary to modify the balls in some way.

The experience at the driving range is too boring to engage any but the most determined golfers. For, they are still just practice areas. They are not very entertaining or engaging enough to transform golf practice into play. Most importantly from a business perspective, they provide no opportunity for the owner of the establishment to attract non-golfers to their facility. Today, the standard practice by owners/management, when planning new golf ranges, is to build in a location where there exists an abundance of existing golfers. After a new range is built, the range owner/manager simply waits for the golfers to come in to practice, with little hope for attracting the casual would-be golfer.

Owners have made attempts to make driving ranges more fun, by adding targets to their range, but targets alone have very limited success. Their success is hampered because targets alone depend on the customer's own ability to recognize the opportunity for him/her to make up a game. Unfortunately, most people are not that creative. Dependant on the type of targets used, can actually make game play more difficult for lack of adequate feedback when targets are struck. The end result is that these targets do little to enhance the owners' ability to promote the use of their facility.

When targets function as part of a pre-designed game without the use of computer automation, score keeping, or display, there is still limited customer acceptance. This is driven by the perception that the score keeping is cumbersome, requires significant human supervision (if official rules are in play), and often the games and the rules are not obvious to the patron. Though this outcome allows owners to promote their facility (i.e. for scheduled/organized events); the games usually have nominal success in attracting would-be golfers.

Totally automated systems are on the other end of the spectrum. These systems work well and provide the desired effect for both the existing customer and range owner. However, the cost of these systems and their installation are beyond the reach of most range owners. These costs are driven by installation, which requires the excavating and building costs making these options very expensive, and the equipment that tends to individualize the play of each golfer system wide. To individualize score keeping and ball identification the systems require specially manufactured golf balls that are compatible with special ball collectors (and ball readers) incorporated into the targets. A few systems have instead used the marking of off-the-shelf balls in some unique manner, which does minimally reduce the owner's ongoing cost. Then there are the individual input and display units found at each tee local on the range. These units are designed to protect the unit from weather, and after-hour abuse, making them very expensive to manufacture. Lastly, these systems much as any other that is electronic in nature, requires computer equipment that can be driven by the number of game stations incorporated into the range.

Examples of such systems are U.S. Pat. No. 3,104,879 to Jetton (1963), describes a driving range that affords golfers the opportunity to practice driving and chipping for distance, provides aids to improve directional accuracy and entertains by rewarding individual golfers who achieve distance and directional accuracy. Jetton's driving range envisions a plurality of flagged holes or cups, simulating a golf green, arranged at various distances from the tee stands with signaling devices to indicate when a ball drops into a cup. It is an example of a target system designed to improve the practice experience. The invention is not a game system per se and does not perform automatic scoring of any kind.

U.S. Pat. No. 5,439,224 to Bertoncino (1995) uses special golf balls with UPC codes combined with an expensive and complex ball collection, reading and dispensing systems. Also, this prior art does not provide immediate feedback in the way of a score and only generates statistics for later review. As such, it is not designed for interactive game play. For small to medium size ranges (10-100 hitting bays), the cost and complexity of the system is a major barrier to adoption.

Pub. No. US 2002/0065567 A1 (Kodera) published May 30, 2002 uses special golf balls with internal passive RF electronics combined with a plurality of targets that catch the ball and forward to a complex ball collection reading and dispensing systems. The inclusion of internal electronics adversely affects the flight characteristics of the ball, making the balls very expensive. The total system cost is prohibitive to most range installations. The invention does address the entertainment and competition scoring aspects. For small to medium size ranges (10-100 hitting bays), the cost and complexity of the system are still a major barrier to adoption.

Inasmuch, there still exists a need for a low cost gaming system that does not require a complex ball collection system.

U.S. Pat. No. 6,569,028 to Nichols, et al. (2003) uses a target subsystem, a detection subsystem and a golf ball dispensing subsystem. It is an example of a target system designed to improve the practice experience. It improves the practice experience thru immediate feedback by use of sounds or lights that activate when the detection subsystem detects that a ball has struck the target. It also improves practice thru the use of colored balls that enable the golfers to see which ball has struck the targets. The invention is not a game system per se and does not perform automatic scoring of any kind. This invention is best described as a Range Play Entertainment system which incorporates features that support group/team play for fun while still supporting the tasks needed to improve individual skills required in the play of golf. This system offers a variety of games, many of which may be played against the clock, which is a very unique feature within golf game systems (as a whole). This system permits team or individual play with simple targets that may be fixed or mobile, any shape, (though the disclosed embodiment described in this document specifies a target designed to facilitate the raising of additional advertising revenue), and require no special equipment to individualize the scoring of the various golfers on the range. The system is portable and may be quickly setup and taken down to minimize vandalism for use indoors or in open fields. It uses wireless communications between the targets, the computer system (called the Game Engine), and the unique Scoreboard geared for group play. The result is that no special installation and no special balls required, so the resulting system is very affordable.

This game system is an improvement over prior art for it does not require complex and expensive ball identification such as that required in Pub. No. US 2002/0065567 (Kodera) or Intl. Pub. No. PCT WO 02/40111. By hitting the target, player(s) receive immediate visual and audio feedback, which thereby reinforces the skills learned during the game-playing session. The player may play against him- or herself, the clock, or other players. The Game Engine (described herein) supports various games and logic.

Game examples include games that require targets to be hit in a specified order, with (or without) time limitations, or with use of the total time required to complete the target sequence used as the score. Yet another game is scored by sensing the highest number of targets hit in a specified time, and another is scored by determining the shortest amount of time in which all the specified targets are hit. These examples are not intended to imply a limitation, but are merely examples of the systems potential. In all these configurations, games support the development of good ball striking skills.

### BRIEF SUMMARY OF THE INVENTION

The present invention is a computer commanded device that uses a plurality of strike detectors to detect a projectile striking a target. Strike detection is forwarded over a communications link to a computer capable of running a plurality of games or practice routines. The score or progress of the game is communicated to the players via an automated common display or scoreboard controlled by the game software.

The strike detector module is housed in a small box attached to the target. The box contains vibration sensor(s), and a microcomputer with its program and parameters that control how it operates saved in a non-volatile FLASH memory device. The strike detector module has a connector that permits additional external vibration sensors to be attached to additional target sections. The output of the strike detector module is a coded signal carried over a wire, infrared or wireless communications which links back to the scoring system. The scoring system updates a common display and generates team ranking and historical statistics.

The targets or target areas may be any desired size or shape, fixed or mobile. The targets may be semi-permanent or portable which allows for setup virtually anywhere. The range operator may, at any time, select which game or practice routine is to be played as well as the duration of that game or practice session. The simplicity and low cost of the system is just one of many advantages over prior art. The current invention allows the user or range operator to quickly set up target(s) at any desired location. It also permits the user or range operator to place the scoreboard in any convenient visible location(s). Changing the game (or practice type) and time duration is done through the game software component.

A wireless communications link connects the strike detector module(s) to the host computer that runs the game software. This software allows the range operator to observe and change all of the operating parameters. In this manner, the operation of the system can be varied depending on the operator's intent. For example, the system can be set to play a game where the entire group of players comprises one team. In another instance, the system can be set to have multiple teams compete against each other.

In view of the background described above, an object of the present invention is to provide a game system that enables players to play a game as a group by use of a golf driving range. While the system provides for the play of many games, the basic method of all of the games is similar. The patrons of the range may function together as a team, multiple teams (or even individuals), playing against the clock, other teams and the scores of previous games. Player division is accomplished by the assignment of targets to scoring entities. There is no individual scoring within these entities, although players can opt to keep track of their own scores.

Before the game begins, the computer sends a message to the banner line of the display device or scoreboard explaining the object of the game, e.g., “the object of the game is to hit each target at least once before time runs out,” and the time clock on the scoreboard is set to a specific amount of time, e.g., 5 minutes. It is recommended that the time limit be set to roughly coincide with the amount of time it takes for a golfer to hit a bucket of balls at a rather quick pace. This will add a dimension of timing to a player's strategy. If players hit balls too quickly, they might sacrifice accuracy. If on the other hand, a player hits too slowly, he/she may run out of time with balls still remaining. This aspect of the game can be compared to a three point shooting contest in basketball.

The game begins as in most competitions when the whistle blows (or other audio or visual indicator), and the clock starts counting down the time remaining. At the start of the game the scoreboard may show that no targets have been hit by setting the counter for each target to zero. Now each player on the range tries to hit any one of the targets in the landing area of the range. When a target is hit, the counter corresponding to that target on the scoreboard is incremented. The players use this feedback to determine which targets have already been hit and which targets still need to be hit. The goal of the players is to either hit each target at least one time or to score as many points as possible. The number of people on the range and where they choose to hit from will impact which strategy to pursue. Ultimately, it is the combination of both that offers the greatest reward possibilities. Play continues until time runs out.

When time runs out, the game is over and the Scoreboard or display device will specify a winning or losing status to the players based on the parameters of the game and the scores of other teams and/or previous scores. For example, if the object of the specific game played was to hit each target at least once before time runs out, and that had been accomplished, the game is won and the scoreboard will flash “WINNER”. Additionally, a variation of the same game might also take into account the total score (the total number of hits on all of the targets). In that case, the current score is compared to the previously recorded high score for a given time period (perhaps over a week or a month). Both the current total and the previous high score are displayed on the scoreboard. If this game represents a new high score the patrons could be made eligible for a second level prize.

Other aspects of this invention will appear from the following description and appended claims, reference being made to the accompanying drawings forming a part of this specification wherein like reference characters designate corresponding parts in the several views.

### BRIEF DESCRIPTION OF THE DRAWINGS

FIG. 1 is a block diagram overview of the disclosed embodiment of the game system.

FIGS. 2A, 2B are detailed perspective views of the disclosed embodiment target.

FIG. 3 is detailed perspective view of the disclosed 3-dimensional embodiment target.

FIG. 4 is a detailed diagram of the game scoring system.

FIG. 5 is a logic flow diagram of the game logic.

FIG. 6 is a schematic diagram of the target sensor electronics.

FIG. 7 is logic flow diagram of the strike detection logic.

FIG. 8 is a schematic diagram overview of the receiver electronics.

FIG. 9A is an alternate embodiment block diagram overview for hockey applications.

FIG. 9B is an alternate embodiment block diagram overview for soccer applications.

FIG. 10 alternate embodiment block diagram overview for baseball batting cage applications.

FIG. 11 is screen graphic of the scoreboard status and main screen.

FIG. 12 is a dialog screen graphic for game selection.

FIG. 13 is a dialog screen graphic for game text messages.

Before explaining the disclosed embodiment of the present invention in detail, it must be understood that the invention is not limited in its application to the details of the particular arrangements shown, since the invention is capable of other embodiments. It is also to be understood that the invention is not limited to golf. In addition, the terminology used herein is for the purpose of description and not of limitation.

### DESCRIPTION OF THE DISCLOSED EMBODIMENTS

Certain terms used herein are defined below:

| | |
|---|---|
| ADC: | analog to digital converter |
| ASCII: | American standard code for information interchange |
| BAUD: | Serial communication data rate in bits per second. |
| Byte: | Digital data word 8 bits in length |
| Character: | a symbol from the ASCII set. |
| Checksum: | A numerical sum of the data in a set or list. |
| CPU: | Central processing unit. |
| EEPROM: | electronically erasable programmable read only |
| | memory. |
| FLASH Memory: | Electrically alterable read only memory. |
| | (See EEPROM) |
| FM: | Frequency Modulation |
| Full | Duplex: Simultaneous two way transmission of |
| | information |
| GUI: | Graphical user interface. |
| Hexadecimal: | Base 16 representation of integer numbers. |
| Half Duplex: | Non-simultaneous bi-directional transmission of |
| | information. |
| IC: | Integrated circuit. |
| I/O: | Input output. |
| Interrupt: | Signal the computer to perform another task. |
| IR: | Infer Red (invisible long wavelength light) |
| IRQ: | Interrupt request |
| LED: | Light emitting diode, solid-state light source. |
| Long word: | Digital data of a 32 bits length. |
| LSW: | Least significant word |
| MSW: | Least significant word |
| Nonvolatile: | retains information after power loss. |
| OC: | Open collector. |
| PC: | Personal computer. |
| PCB: | Printed circuit board |
| RF: | Radio frequency |
| RFI: | Radio frequency interference. |
| RFID: | Radio frequency identification. |
| ROM: | read only memory. |
| RS-232: | Serial communication format standard. |
| RSSI: | Received signal strength indicator |
| SCR: | 4-layer thyrisor device (2 transistors back to back) |
| USB: | Universal serial bus |
| UART: | Universal asynchronous receiver transmitter |
| VS: | Vibration Sensor |
| Word: | Digital data in a 16 bit length |

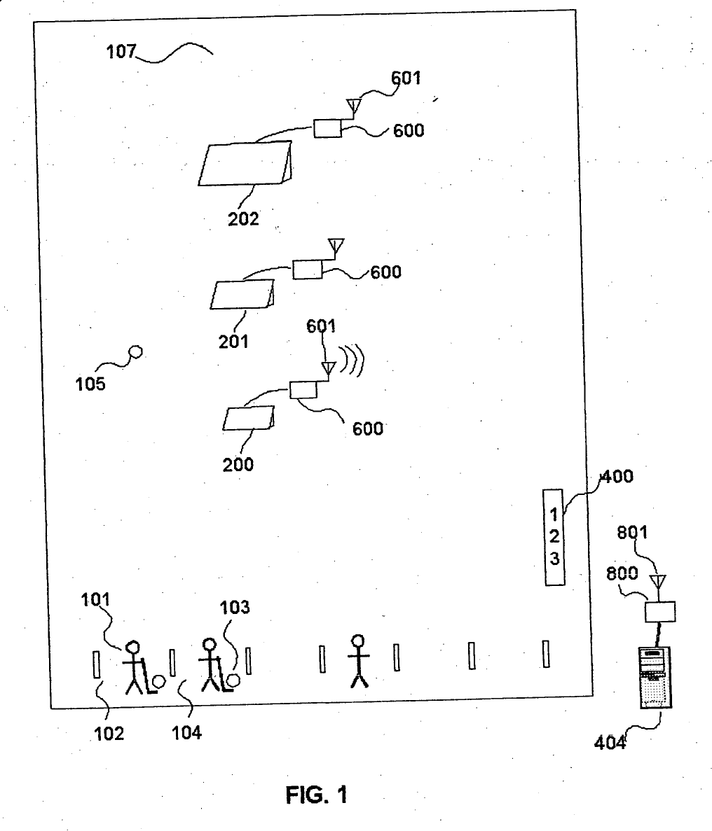

### FIG. 1

FIG. 1 is the disclosed embodiment of the game system applied to a golf application. Player 101 stands in one of the available hitting bays (such as 102 or 104) and strikes a ball. Struck ball 105 hits target 200 one of the available targets (200-202) that are placed at various distances and locations in landing area 107.

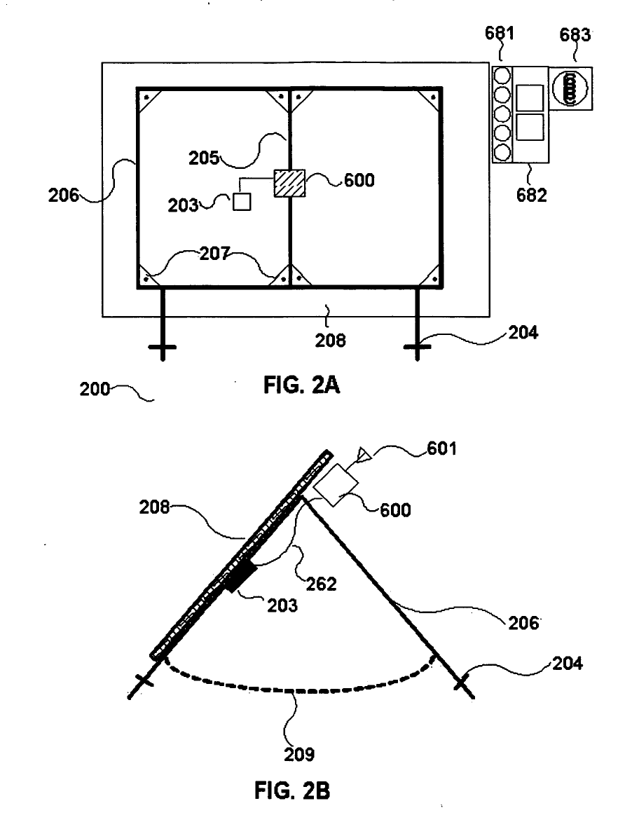

Vibration sensors 203 (FIG. 2) are attached to each target 200-202. The sensor detects the ball strike and alerts strike detector 600. Strike detector 600 records the force or amplitude of the strike and transmits a RF coded message over wireless link antenna 601. The coded message includes identification information as to when and which target was struck. The RF link is offered by way of example and not limitation; an optical or wired link could be employed to save cost or avoid RF regulatory issues.

Antenna 801 receives the coded RF signal and sends it to transceiver 800. Decoded signal (RS-232) 407 is sent to computer 404. Other common communication links such as USB or wireless may be used. The decoded signal 407 is sent to the game program for updating internal scoring and scoreboard 400. Selection of the size and location of targets 200-202 can simulate shots used in actual game play. For example, targets 200-202 could accurately simulate a short pitch with a wedge, medium iron shot and long distance drive respectively. This way the player can practice “placing” the ball to improve his or her skill level or practice scoring points when competing with other players. The current invention transforms the mundane practice session into fun.

### FIGS. 2A and 2B

FIGS. 2A and 2B are perspective views of target 200. The target has a durable board or rigid panel 208, which is made from a material such as polycarbonate plastic as used in the disclosed embodiment. Other materials are substantially equivalent, such as plywood or metal. Rigid panel 208 (landing surface) is supported and affixed to frame 206, which is anchored to the ground by legs 204. Attachment of panel 208 to frame 206 may be temporary for special events or fixed for more permanent installations such as a driving range. Panel 208 forms a sounding board. Vibration sensor 203 is attached to frame crossbar 205 or panel 208. The size of panel 208 can be varied so that smaller targets can be used at shorter distances from hitting bays (102 and 104 of FIG. 1) and larger targets can be used at greater distances.

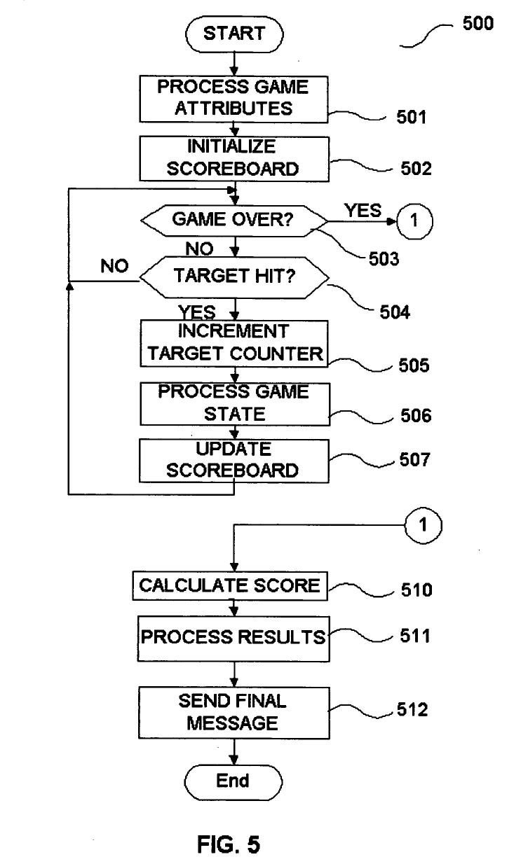

Strike detector 600 measures and records the force/amplitude of the strike then transmits a RF coded message over a wireless link antenna 601. Strike detector 600 alternately drives visual feedback lamp 683 that flashes when the target is struck. In the disclosed embodiment, a Xenon flash lamp is used but other light sources such as an LED are substantially equivalent. The feedback lamp alerts the player(s) that the target has been hit. In another embodiment, strike detector 600 drives visual feedback bar display 628 when the target is struck. The feedback bar is incremented each time the target is hit (see FIG. 5).

In addition, to the acoustic and visual feedback coming directly from target 200, the signal sent from the target 200 triggers the update of display device or scoreboard 400 (see FIG. 1) and may alternately trigger electronically produced sounds such as beeps, crashes, or a digitized human voice via speakers installed in the hitting area. The player(s) receives immediate feedback in many forms thus strongly reinforcing that a target has been hit.

FIGS. 2A and 2B also shows target support structure/frame 206. In this embodiment, support structure 206 is a metal frame, which is designed to support the landing surface 208 and position it at the desired angle. The frame 206 is shaped as a rectangle with a vertical crossbar 205 with legs 204 extending at the bottom. Two of these structures are connected at the top with a hinge. The result is support structure 206 that opens at the bottom facilitating both the stable support of the landing surface 208 and the formation of the desired angle of the landing surface 208 to the ground. In another embodiment of the invention, a rigid panel 208 could be attached to both the front and backsides of the support structure 206. In this embodiment, a landing surface 208 is only attached to the surface positioned to face the hitting area of the range.

The landing surface 208 is attached to target support structure 206 with either clips or screws at attachment points 207. A pair of chains 209 or lengths of metal strips with perforations for clips or screws are attached. Chains are attached on each side of target support structure 206 enabling the hinged front and back sides to be expanded at the bottom creating the desired angle for the landing surface 208. The desired angle of the landing surface 208 to the ground will vary, the common angle range will be from 45 to 60 degrees depending on the distance between the target and the hitting area (102 and 104). The closer to the hitting area the smaller the angle. The vertical crossbar 205 also functions as the support structure for strike detector 600. This example shows one possible design for target construction but is limited by it.

Targets for this invention are designed so that a ball striking the target produces a sound acoustically audible to the players and to provide for the deflection of the ball off the surface. This is an important distinguishing factor from prior art such as U.S. Pat. No. 5,439,224 (1995) and Intl. Pub. No. PCT WO 02/40111 A1. Otherwise, when a ball lands in, and is consumed by a target structure, it is very difficult to perceive with our un-enhanced human sensory capabilities. In essence, the ball disappears when it lands in the target. In the present invention, targets are designed to enhance the factors that contribute to human perception in both visual and audio modes. This immediate feedback is essential to fun and excitement of a gaming system. The longer the delay, the more muted the feedback and the less rewarding the experience.

Targets for the present invention are also designed with the idea of being able to support sponsorship by providing a surface on which companies can place advertisements. This is an important factor in the commercial success of the system in that it helps defray the cost of the system to range owners while at the same time offering a unique marketing opportunity, especially for those companies with an interest in selling goods to golfers.

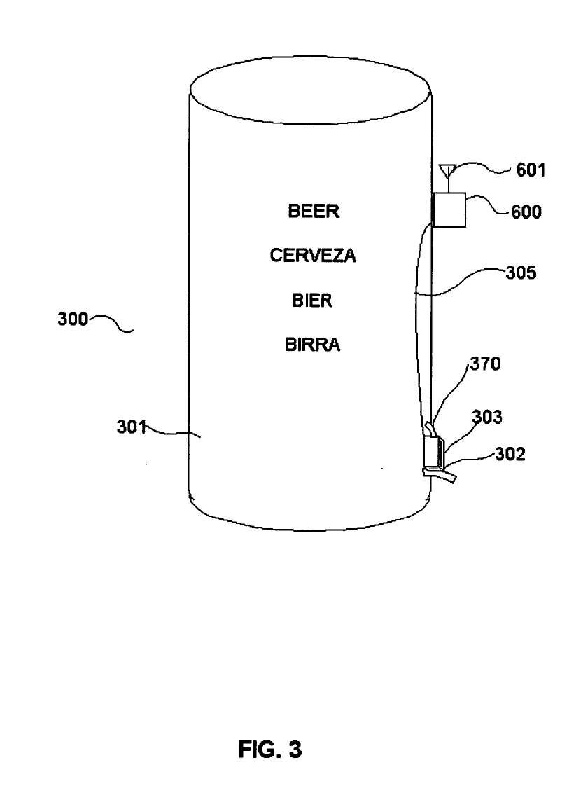

### FIG. 3

FIG. 3 is a perspective view of an alternative embodiment of target 300 that has an inflatable plastic or rubber surface 301. Target 300 is inflated through spout 302. A pressure sensor 303 is attached to spout's 302 plug. When a ball strikes target 300, the force of the ball compresses the air inside rubber surface 301 thus increasing the pressure being exerted on pressure sensor 303. Pressure port 370 on the pressure sensor detects the pressure change. Pressure sensor 303 sends an electrical signal proportionate to the pressure within the target to strike detector 600 though communications link 305. Strike detector 600 sends a signal via wireless link antenna 601.

The large inflatable beer can depicted in this figure represents the flexibility of the current invention as it relates to target configuration. In the disclosed embodiment of the invention, a target with rigid panel 208 is mounted on a support structure 206 as depicted in FIGS. 2A and 2B. However, the system is easily adapted to many target configurations and compositions. In the example shown in this figure (FIG. 3) a large inflatable beer can is representative of the type of promotional display often seen at sporting events. With only a change in the sensor device, vibration sensor 203 to pressure sensor 303, the current invention is easily adapted to work with different target types. The remainder of the system remains unchanged.

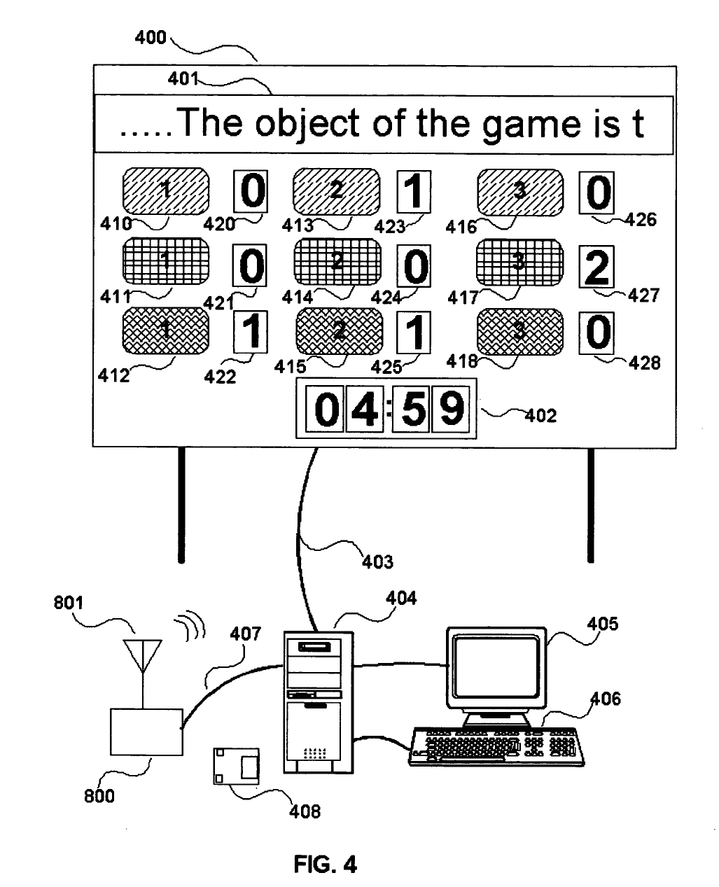

### FIG. 4

FIG. 4 is a diagram showing an overview of the scoring and communications components of the system. The scoring process starts when the antenna 801 receives coded RF signal from one of the targets (200-202). The signal is processed by transceiver 800. The transceiver sends a decoded digital message to computer system 404 via RS232 link 407. The game program (see FIG. 5) processes this message. FIG. 5 also demonstrates how the program controls the display device or scoreboard 400 by sending messages via communications link 403. Even though display device or scoreboard 400 will differ slightly from installation to installation, depending on such conditions as specific target layouts, viewing distances and lighting conditions, each display will be substantially equivalent. All versions of the display 400 will contain the common elements of target labels 410-418, corresponding numeric counters 420-428, time clock 402 and banner line 401. Game logic 500 (FIG. 5) updates time clock 402 and numeric counters 420-428. Computer monitor 405 and keyboard 406 are used by a systems operator to set system controls. Computer disk 408 is used to update the game logic 500.

Banner line 401 plays an important role in the present invention. It communicates to the players such information as when a game is about to start, the rules of the game, the outcome of the game and whatever rewards or prizes (optional) are available to win or given to players. It can be used to communicate any message the range operator wants to send to his or her patrons.

The time clock 402 is a unique aspect of the current invention. None of the prior art suggests the use of time as an element of the game. The element of time is crucial to the current invention in that it gives players something to compete with other than each other. It is an important factor from a business perspective as well, because in playing against the clock, patrons are likely to hit more balls in a shorter period of time. For the range owner this translates to more revenue.

The present invention is designed to immediately engage the range patrons. When they walk onto the range they get the feeling of walking into a sports arena. The scoreboard 400 and the banner line 401, in particular, communicate to the patrons the important message, that the range is no longer a place just to practice but a place to play and compete as well.

The automatic scoring system is a critical component of the current invention. It performs two vital functions: first, it invites and teaches games play. Adding this dimension to the range, patrons can play a game and practice their swing. Game play also increases the entertainment value of the activity. Second, it provides automatic score keeping. Driving ranges that do not have a scoring system only have gaming potential. While most ranges have a set of targets, it is up to the players to realize the opportunity and to then devise such a game, or if the range has pre-designed games it must be taught to the players and scores manually maintained. Manually keeping score and playing non-standard games is time consuming, thereby slowing down range play. Therefore the automatic score keeping makes the process easier and less time consuming to the player. It also allows for time dependant game play and maximizes range usage and profits.

### FIG. 5

FIG. 5 represents the control logic of the game-processing engine. Source listings of the Visual Basic code are found in the computer program-listing appendix. The material on compact disc is incorporated by reference pursuant to 37 CFR 1.77(b)(4). That is, the logic represented by FIG. 5 is not for any particular game supported by the system, but rather common logic for all games supported by the system. As shown in FIG. 5, operation 501 first reads and sets the game attributes for the particular game being started by the scheduler program (not shown). These attributes determine what constitutes the end of the game and what intermediary states or stages the game might enforce. For example, the end of game might be determined by either time running out or by the completion of one or more tasks, i.e., all targets having been hit. Additionally, attributes could define a sequence of events that must occur in a specified order. For example, a specific game might require that a certain target be hit first before any other target can register a hit.

In operation 502, electronic scoreboard 400 is initialized. Initialization includes setting counters 420-428 to zero, sending a message to scrolling banner line 401 that tells the players what game is being played and the rules of that game, and the time clock 402 is set and started.

As shown in operation 503, 504, 505, 506 and 507, the program now enters a loop. In operation 503 the program checks to see if the game is over. Depending on the specific game being played and the attributes set in operation 501 the comparison can be either to determine whether time has run out or the necessary tasks have been completed (i.e. each target 200-202 has been hit a least one time). Assuming the game is not over, operation 504 checks to see if any target 200-202 has been hit. If so, the corresponding internal counter is incremented in operation 505. Operation 506 checks for changes in the game state and then process them. For example, if a specific game requires that a certain target be hit first, before the any other target can register a hit, operation 506 would determine when the initial target was hit and change the state of the program to allow other target hits to be scored. Then, in operation 507 the scoreboard is updated to reflect any counter 420-428 changes. The game proceeds, looping through operations 503, 504, 505, 506 and 507 until in operation 503 it is determined that the game is over.

Operation 510 calculates the total score, and then operation 511 compares the current score with previous high scores, sets the appropriate message to be communicated to the players, and saves the score for future reference if necessary. Comparing the final state of the game with the conditions set by the game's attributes determines whether or not the game has been won. If it is determined that the game has not been won (was lost), then in operation 512 a message is sent to scrolling banner line 401 of electronic scoreboard 400 informing the players they have failed to complete the game successfully. If instead in is determined the game has been won, the message sent to the scrolling banner line 401 informs the players that they won, their total score, and information relating to possible prize collection.

The importance of the game engine logic is that it supports a large number of specific game possibilities. This simplifies the creation of entirely new games, but also provides the range operator with countless variations on a particular set of games. By simply changing the parameters such as the duration of the game, the order in which the targets must be hit in, or which team is assigned which targets, the nature of the game can be dramatically changed. For example, if the range were full of patrons, involving all of the targets in the game would be appropriate. However, if there are only a few patrons at the range at a given time, a subset of the targets could be specified.

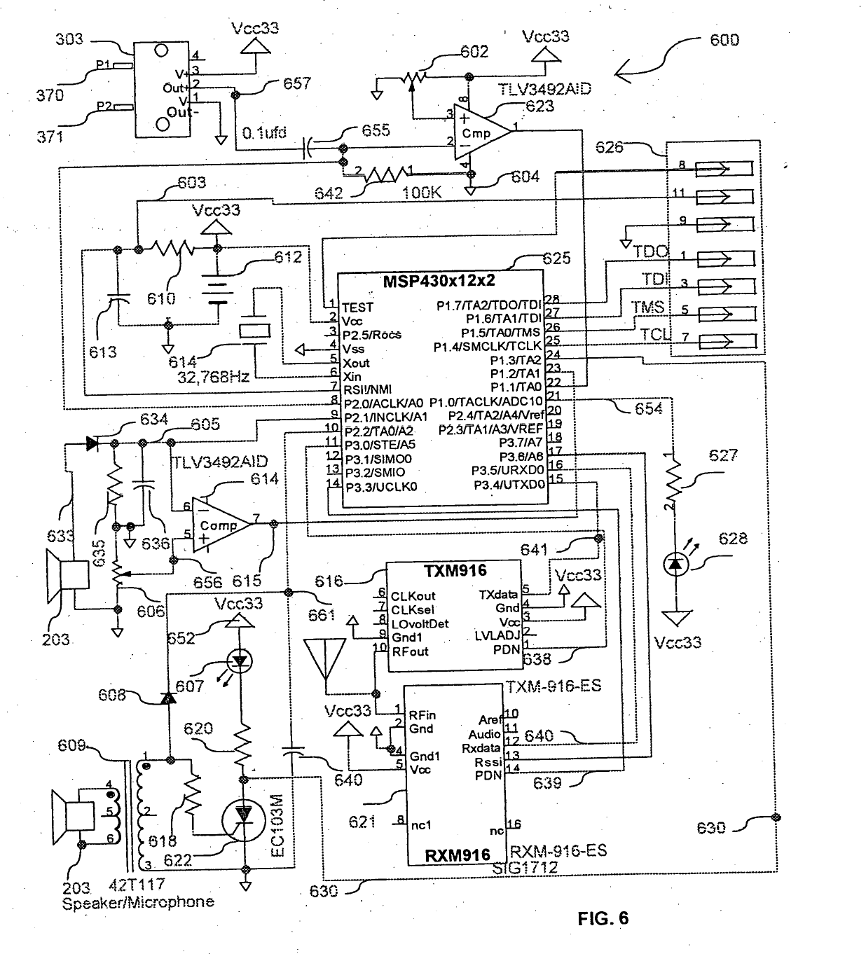

### FIG. 6

FIG. 6 is an electrical schematic of strike detector 600. The first side of external speaker/microphone 203 is connected to returned ground 604. The second side of external speaker microphone 203 is connected to anode of diode 634. Cathode of diode 634 is connected to resistor 635, capacitor 636, analog input pin 9 of microcontroller 625 and inverting input of comparator 614. Potentiometer 606 connected between ground 604 and the supply rail, which forms a voltage divider. The wiper of potentiometer 606 is connected to the non-inverting input of comparator 614. In the disclosed embodiment, comparator voltage 656 is set to 60-mv. For very large targets, where greater sensitivity is required, a lower comparator voltage 656 setting is selected. Texas Instruments TLV3491 or TLV2702 comparator was selected for is low power operation (less than 1.2 microamperes). This device is offered by way of example and not limitation. This low power design permits attachment of one or more inexpensive dynamic speaker/transducer/microphone(s) 203 or pressure sensor 303 to a target of any size or shape.

In the disclosed embodiment, a low cost 600-ohm water resistant Mylar speaker is employed as the dynamic vibration sensor 203. Said speaker is self-powered (zero current), offers weather resistance, rugged, low cost, and provides ease of mounting to virtually any surface. External sensor 203 is mounted directly to a PCB with the microcontroller 625. The sensor module 600 is acoustically coupled to the target. The internal vibration sensor 203 will be selected for sensitivity. PCB mounting makes more devices available, as weather resistance is not a requirement.

Dynamic transducers are offered by way of example and not limitation. In an alternate embodiment, a non-dynamic (amplified) sensor (such as microphone, accelerometers, pressure, vibration, or transducer) offers greater sensitivity but require external power, making this circuit less compatible with low power battery operation. Sensor(s) 203 acoustically/mechanically coupled to target 200 (FIG. 1) detects object 105 (FIG. 1) striking target 200, thereby generating an output signal 633. Diode 634, resistor 635, and capacitor 636 form a simple low pass filter and peak detector. When capacitor voltage exceeds comparator 614 trip voltages, the compared output generates signal 615 to microcontroller 625.

### Non-Ridged Targets

Inflated toys or advertising promotional items are often constructed from an elastomer, which cause such items to transmit sound very poorly. This presents a challenge in the detection of a strike on such an object. Replacement of the vibration sensor 203 with a pressure sensor, dynamic or amplified, 303 permits the same methods previously described to detect a sudden increase in pressure. One example of a pressure sensor is Honeywell DC002NDR5 (used in current invention).

### Microcontroller

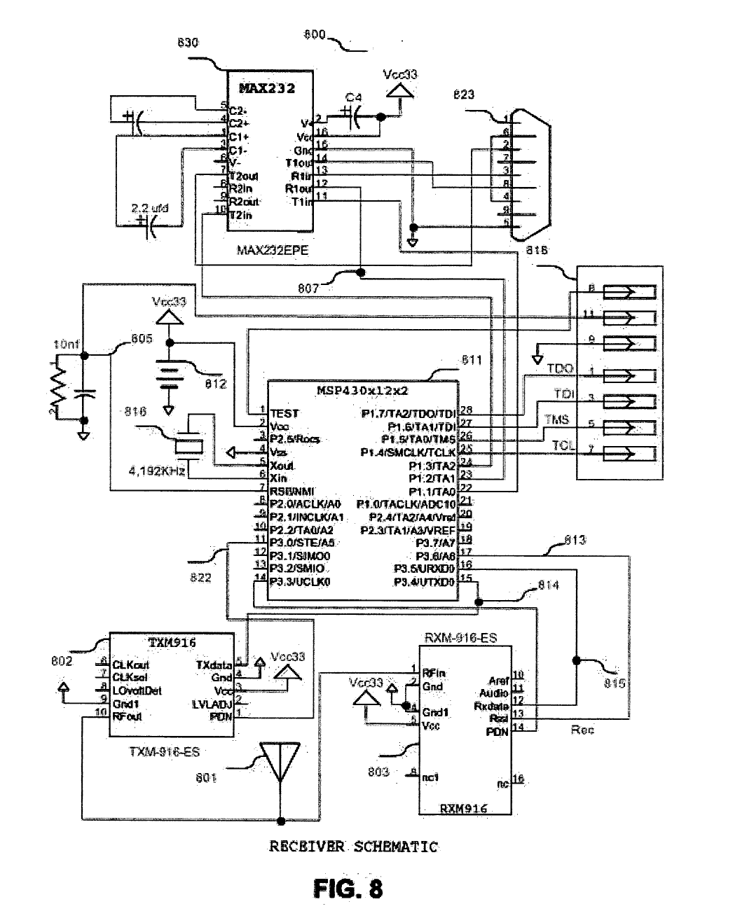

The sleeping microcontroller 625 is awakened by the interrupt generated by the rising edge of signal 615. By way of example and not limitation, microcontroller MSP430F1232 (manufactured by Texas Instruments) was selected for its very low power requirements. In the microcontroller interrupt service routine (source code is located in the computer program-listing appendix), the source of the interrupt is determined while the peak voltage 605 is read by analog input. A coded message is generated and placed in a message buffer for transmission by the communications link. Communications links such as RF or IR optical are substantially equivalent and are offered by way of example and not limitation. Further, by way of example and not limitation, 916 MHz transceivers TXM-916-ES and RX-916-ES, manufactured by Linx Technologies Inc., were used in the disclosed embodiment. Upon detection of a pending message for transmission, RF transmitter 616 is enabled with signal 638. After allowing a few milliseconds for RF transmitter 616 to stabilize, serial data 641 is transmitted by antenna 601. Microcontroller 625 asserts receiver module 616 enable line 639. Radio transceiver 800 (FIG. 8) receives the coded message then transmits an acknowledgement back to the strike detector 600.

The communications received by radio transceiver 800 are checked for errors and forwarded to host computer 404 (FIG. 4). Game controller logic 500 (FIG. 5) updates scoreboard 400. Receiver module 621 demodulates acknowledgment 640. After receipt of acknowledgement, microcontroller 625 goes back to sleep. If there are errors, the coded message is sent to strike detector 600 three times before going back to sleep. The operation of pressure transducer 303, (DC blocking) capacitor 655, resistor 642, potentiometer 602, comparator 623 is identical to 614A except for peak detection and low-pass filtering, which are done in software. By way of example and not limitation, comparators 623 and 614A are Texas Instruments TLV3492 and were selected for their very low power requirements.

### Ultra Low Power Strike Detector

In an alternate embodiment, transducer 203 is connected to the primary of impedance matching transformer 609. The secondary of transformer 609 is connected to series diode 608 and series resistor 618. The second side of series diode 608 is connected to capacitor 640 and analog input pin 10 of microcontroller 625 forming a peak detector. The second side of resistors 618 is connected to gate of SCR 622. In the disclosed embodiment, SCR 622 is a sensitive gate type device such as the Teccor Electronics EC 103M, which requires only 12 micro-amperes of gate current and is offered by way of example, not limitation. The cathode of SCR 622 connects to pin 6 of transformer 609 and the second side of capacitor 640. The anode of SCR 622 connects to signal 630 and the first side of series resistor 620. The second side of 620 connects to LED 607 cathode and to battery power 652. The output of matching transformer 609 is connected to a simple diode peak detector 608. Peak detected signal 661 is applied to an analog comparator input of microcontroller 625. This permits processor 625 to be put in low power mode or to sleep (stopping all clocks), thus reducing the processor current to less than 1-microampere. The current required by the SCR in the “off” state is less than 100-nanoamperes. The dynamic vibration sensor generates the required 12-microamperes to trigger the SCR into a conducting state, pulling the anode terminal low and generating an IRQ waking up sleeping processor. By using a dynamic or self-generating sensor to wake up the microcontroller 625, ultra low power operations are achieved. The SCR also offers high noise immunity, low cost, ruggedness, ESD resistance, and virtually zero operating (device leakage <100 na) current.

### Programming Port

Programming connector 626 connects to the programming pins of microcontroller 625 permitting the program to be loaded into FLASH memory and debugged. Microcontroller 625 and supporting circuitry 623, 616 and 621 are powered by battery 612 (a 3-volt lithium cell) in the disclosed embodiment. In a typical application a single AA battery would power the system for approximately 1 year. Standard 32 KHz watch crystal 614 connected to pins 5 and 6 provides the time base of microcontroller 625. Resistor 610 and capacitor 613 connect to the reset (pin 7) of microcontroller 625 providing a power on reset.

### Target Operation

Description is provided under the description of FIG. 2.

### Player Feedback

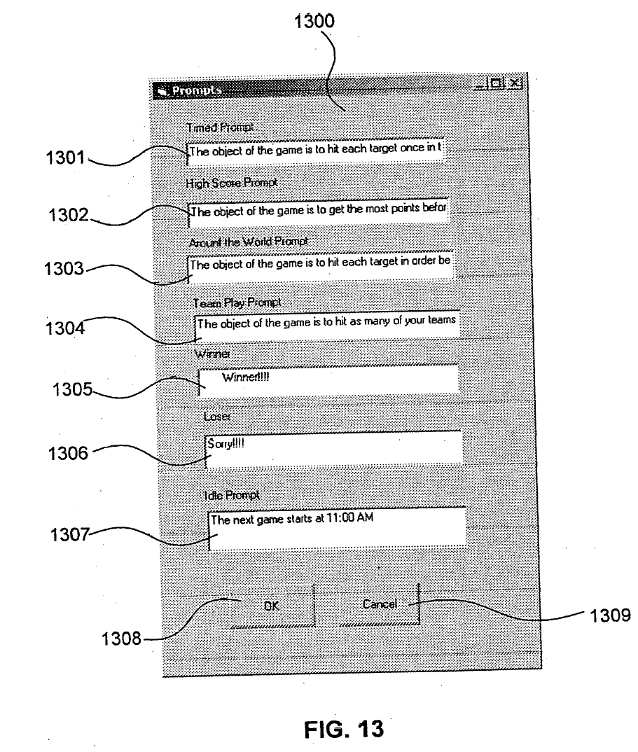

In the disclosed embodiment, computer 404 sends an acoustic feedback signal from load speaker when a coded message is received from receiver 800. In alternate embodiments, active acoustic feedback may be placed at the target(s) 200-202 or near player 101. To add an additional dimension to the game, various digitized sounds such as a “bang” or a human voice to alert the player(s) that the target has been hit can be added. For fun a variety of sounds may be emitted as the game progresses. For example, phrases such as “ouch”, “hit me again” or the sound of breaking glass may be played with each “hit”. Additionally the computer 404 may emit (during game play) prerecorded phrases such as those listed in 1301-1307 (FIG. 13), or that count down the clock or give commands that enabling phrases or sounds to be played by the desired strike detector 600. For example, phrases such as “try to hit me” would be played to alert the players to the next target. In some target configurations where the acoustic feedback would never be heard or volume levels required would be impractical, strike detector 600 automatically triggers feedback lamp 683 when strike is detected. The disclosed embodiment uses a Xenon flash lamp but other light sources (such as an LED) which are substantially equivalent, may be used. Lamp 683 may illuminate the target or be directed toward the players.

In parallel with the acoustic and visual feedback, scoreboard 400 (FIG. 4) is automatically updated with each impact detected. Thus, the player(s) receives immediate feedback scoring. This is an improvement over prior art manual score cards. The flexible design permits the use of a wide range of low cost sensors. The ultra-low power operation permits typical operation for a year or more on two AA batteries. Simplicity, low cost, ruggedness and small size of the current invention make it well suited for the task. Combined with the interesting games (FIG. 5) and immediate feedback given during play, this system is a significant improvement over prior art.

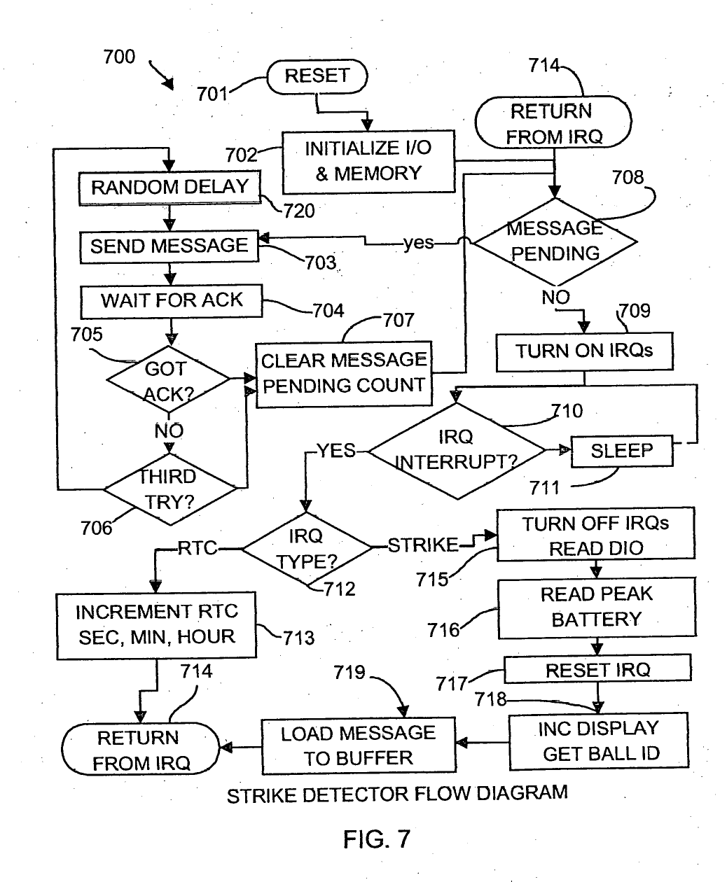

### FIG. 7

FIG. 7 is a logic flow chart diagram of the strike detector 600 operations. After power up, reset operation 701 begins with operation 702 initializes variables and microcontroller I/O. In operation 708 the message count is checked. If no messages are pending, then the program continues to operation 709, which enables the interrupts from the digital inputs to be driven by comparator(s) 615 (FIG. 6). If no interrupts are pending in operations 710, microcontroller 625 is placed in a low-power sleep mode 711.

The Flash/EEPROM serves multiple functions, and is divided into a number of separately erasable memory blocks. Each block is used for program storage, variables, and system ID data. Firmware is programmed at the factory via JTAG port 626 (FIG. 6). The boot firmware checks the normal firmware block for valid firmware code and begins executing it. If no code is present, the controller waits for a diagnostic computer to be connected that handles loading and programming of new firmware.

### RTC Interrupt

Upon receipt of an interrupt, operation 712 determines the source of the interrupt. An internal timer generates a periodic one-second interrupt used to maintain a real-time clock RTC. In operation 713, the real-time clock units of hours, minutes and seconds are incremented. Upon completion, a return from interrupt 714 is executed.

### Strike Detector

Vibration sensor(s) 203 (FIG. 6) generates a signal after an object strikes target 200. Comparator 614 generates a signal that initiates an interrupt in microcontroller 625. The sleeping microcontroller determines the source of the interrupt in operations 710 and 712. In operation 715, external interrupts are temporarily disabled and the specific digital input receiving the interrupt is determined. This permits a plurality of sensors 203 to be attached to very large targets 200 to guarantee strike detection in alternate multi-section target configurations, e.g. a bull's eye. Sensors 203 are attached to each subsection permitting assignment of different point values to target sections. Once the specific digital input channel has been identified, the corresponding analog input channel 604 is read. The peak voltage, already on the analog input channel, is proportional to the force or speed at which target 200 was struck. In operation 716 the ADC reads battery 612 voltage. If a latching SCR 622 is used in place of comparator, operation 717 resets the SCR. The reset is accomplished by setting digital input as an output. Setting output 630 low diverts current away from the SCR, thus resetting the device.

Operation 718 enables control signal 654 to flash visual feedback lamp 628 (FIG. 6) thereby providing additional immediate feedback that the target has been hit.

### Send Message

In operation 719 (FIG. 7) the message is loaded into an output buffer for transmission at a later time. Message count register is set to three. Upon completion, a return from interrupt 714 is executed.

### Returned from Interrupt/Send Message

Operation 714 (FIG. 7) is a standard return from interrupt where the stack is restored and program execution resumes. With the message pending, operations 708 switches to operation send message 703. In operation 703, coded message 641 is sent via UART for transmission over RF to communications module 616 (FIG. 6). In the disclosed embodiment, simple clear ASCII text is transmitted. This is offered by way of example and not limitation, as other encoding methods such as binary are equivalent. A binary message format would be used to shorten message transmission time if additional power savings were desired. In the disclosed embodiment, coded message 614 includes a unique target ID number, sub-target number, strike amplitude/force, RSSI, battery voltage, time stamp and checksum. Additional diagnostic parameters are easily added to the outgoing message string. In alternate embodiments, for example, additional sensors such as “tilt”, to report a target blown over by wind, can be added. Detection and reporting of open/defective or unplugged external sensors 203 is easily implemented. Automatic reporting of the battery voltage permits the host computer to report a low battery and schedule replacement. A low RSSI may require antenna adjustment or reposition.

### Wait for Acknowledgement

In operation 704, receiver 621 is taken out of its powered down state with the assertion of line 639. Receiver module 800 sends an immediate acknowledgment after accurate receipt of a coded message from 600. Upon receipt of acknowledgment in operation 705, the receiver module is placed in a low power state and the message pending count is cleared in operation 707. Else, message pending count is decremented and operations 720, 703, 704 and 705 are repeated. A short random delay 720 of 10-100 mSec is added between transmissions to reduce the chance of message collision. After three attempts, transmitter 616 and receiver 621 are powered down in operation 707.

### FIG. 8

FIG. 8 is a schematic diagram of receiver system 800. Microcontroller 811 with radio transmitter 802 and receiver 802 and minimal support components make up receiver 800. Voltage regulator 812 is shown as battery for simplicity, providing power to internal circuitry. Crystal oscillator 816 provides the clock to microcontroller 811 to operate time base and internal timers. The master program is stored for execution in FLASH memory, local RAM stores temporary variables generated during operation. The ADC contained in microcontroller 811 samples RSSI 813 to aid in antenna 601 and 801 placement or orientation. RSSI and battery charge status for each sensor module 600 is reported back to host computer 404. The microprocessor is a Texas Instruments MSP430F1232. This device is offered as a way of example and not as a limitation as other low power processors are equivalent, such as the Chipcon CC1010 RF transceiver.

### Operation

Standard 9600-baud asynchronous messages are sent from strike detector(s) 600 to receiver 803 and decoded by UART internal to microcontroller 811. Received messages are checked for errors. If error free, acknowledgment signal 814 is transmitted to strike detector(s) 600. The error free decoded message is echoed to a second UART and buffered by RS232 transceiver 830 to host 404 (FIG. 4) via connector 823 and cable 407. Diagnostics port 818 is not connected during normal usage but is used for debug and software updates. Microcontroller 811 contains counter/timer circuits that are used to generate various time delays, and to generate one-second periodic interrupts for internal timing. Due to normal receiver noise and random nature of the strikes, microprocessor 811 is constantly receiving characters and constantly looking for received messages from strike detector(s) 600 on line 815. In this application, speed is critical as the processor must be available for all incoming messages and to provide a timely acknowledgment. For simplicity, a single frequency simplex system is used. This has the disadvantage that some messages will arrive at the same time and will interfere with each other. As messages are random and sent infrequently, the chance of collision is very small. To further minimize data loss each strike detector 600 adds a random delay between retries. In an alternate embodiment, a frequency agile transceiver such as the CC1010 (mentioned above) may be used for greater distance or in high noise environments.

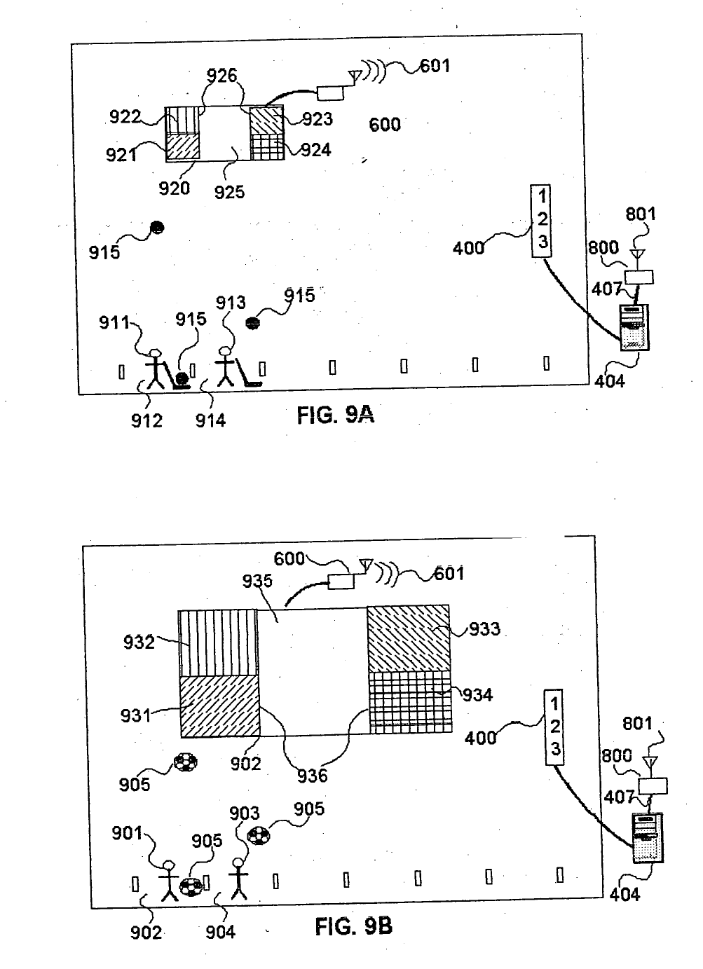

### FIG. 9

FIG. 9A is an alternate embodiment of the game system applied to ice hockey applications and FIG. 9B is an alternate embodiment block diagram overview for soccer applications. Player(s) 901, 903, 911 and 913 are in hitting bays 902, 904, 912 and 914 and strike either puck 915 or ball 905.

In the case of ice hockey puck 915 hits target(s) 920 placed at various distances and locations. Target 920 may be made of a plurality of segments 921-925 to simulate puck placement in various simulated goal locations. For example, the upper corners 922-923 are more difficult to guard and could be assigned a greater point value.

Likewise, in the case of soccer, struck ball 905 hits target(s) 902 placed at various distances and locations. Target 902 may be made of a plurality of segments 931-935 to simulate ball placement in various simulated goal locations. For example like with hockey, in a soccer net the upper corners 932-933 are more difficult to guard and could be assigned a greater point value. The targets 902 and 920 would be typically the same size as regulation goal nets. Hinges between segments at 926, 936 for example permit folding target 920, 902 in half to accommodate easy transportation and storage.

Vibration sensors 203 (not shown) are attached to each target section 921-925, 931-935 to detect the ball strike and alert strike detector 600. Strike detector 600 records the amplitude of the strike and transmits a RF coded message over wireless link 601. The coded message includes identification information as to when and which target was struck. The RF link is offered by way of example and not limitation. An optical or wired link could be employed to save cost or avoid RF regulatory issues. Antenna 801 receives coded RF signal to transceiver 800. Decoded signal 407 is presented to computer 404. Decoded signal 407 in the disclosed embodiment is serial RS-232. However, other common communication links such as USB or wireless may be used.

Decoded signal 407 is transmitted to the game program for automatic scoring and updating scoreboard 400. Scoreboard 400 maybe co-located with target 902, 920 to reduce cost. Selection of the size and location of the targets 902 and 920 can simulate shots used in actual game play. This way the player can practice “placing” the ball/puck to improve his or her skill level or score points when competing with other players.

The current invention transforms the mundane practice session into fun. This current invention also addresses automatic score keeping. In addition, the current invention is smaller and lighter than a standard goal/net thereby allowing quick setup. As stated above, hinges 926, 936 permit folding the target thereby providing a compact size for ease of transportation setup and storage. The game system permits playing a variety of games that target specific skills. The system also facilitates games that permit team or individual competition. By hitting the target, player(s) receive immediate visual and audio feedback and reinforce the skills learned. A player may play against him- or herself, the clock, or other players. The current invention includes a game engine that supports various games as taught in FIG. 5. For example, games are offered that require specific target sections to be hit in a specified order, the most targets hit in a specified time, and all target sections being hit in the shortest amount of time, all of which support the development of good striking skills.

Unlike the prior art in the field, a unique aspect of the current invention is the ease with which it can be applied to other sports. Small modifications to the target geometry and configuration allow the system to be applied to any sport where accuracy skills involving some sort of projectile such as a ball, bullet, puck, or disc.

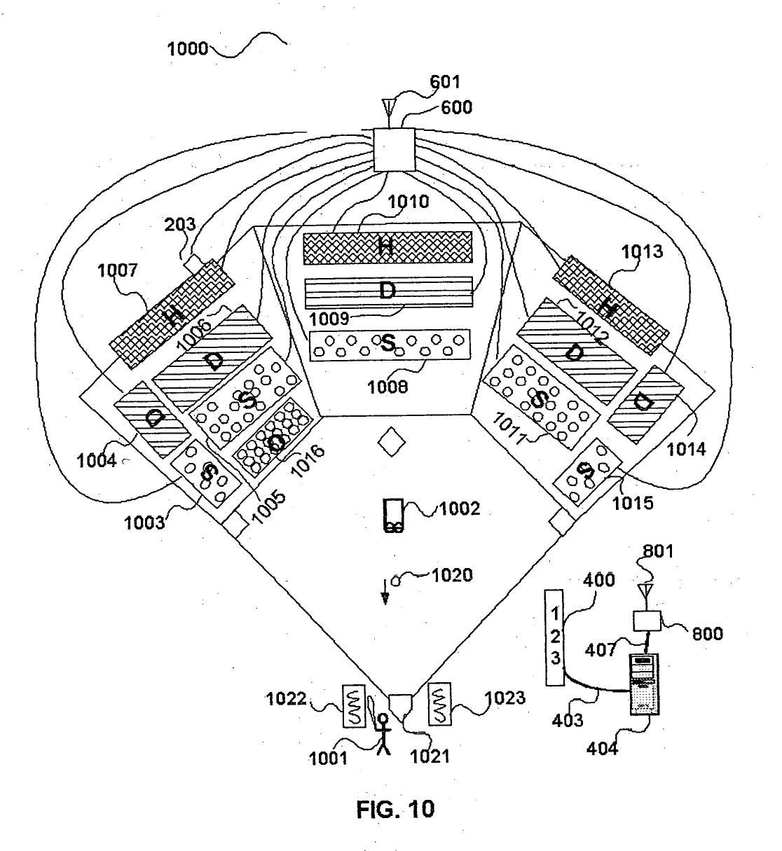

### FIG. 10

FIG. 10 is an alternate embodiment of the system applied to a baseball batting cage application 1000. Batter 1001 standing in batters boxes 1022-1023 on either side of home plate 1021 strikes ball 1020 from automatic pitching machine 1002. When striking ball 1020, batter 1001 attempts to direct ball 1020 at targets 1003-1010 or 1011-1015. Vibration sensor 203, shown attached to target 1007, is similarly attached to the other targets, and detects the ball strike thereby alerting strike detector 600. Strike detector 600 records the force or amplitude of the strike transmits in a RF coded message over wireless link antenna 601. The RF link is offered by way of example and not limitation, an optical or wired link could be employed to save cost or regulatory issues.

Antenna 801 receives coded RF signal to transceiver 800. Decoded signal 407 (serial RS-232) is presented to computer 404. However, other links such as USB or wireless may be used. Decoded signal 407 is transmitted to the game program via communications link 403 for updating internal scoring and scoreboard 400. Selection of the size and location of the targets may closely simulate actual game play. For example, targets 1003-1004 and 1014-1015 would accurately simulate a “line drive” to the left and right lines, respectively. This way the player can practice “placing” the ball to improve his or her skill level or can score points when competing with other players. Targets 1007, 1006, 1005 and 1016 simulate triple, double, single, and out, respectively. The force the target is struck with combined with the spatial location permits differentiation between, for example, a home run and a triple when targets 1007, 1010 or 1013 are hit. The current invention transforms the mundane practice session into fun. The player receives immediate feedback thus reinforcing the skills learned. The player may play against him or her self, the clock or other players. The current invention includes the game engine taught in FIG. 5. However, a variety of games are offered. For example one game could require specific targets to be hit in successive order while another game might simulate an actual baseball game.

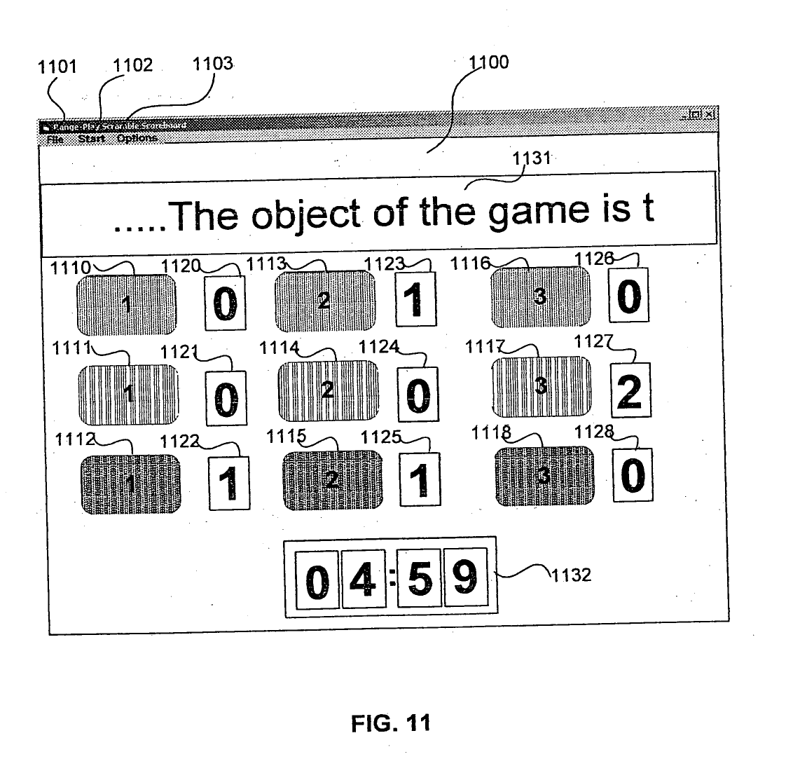

### FIG. 11

FIG. 11 is a screen graphic of the applications main screen 1100. This screen is designed to emulate the systems scoreboard. While the game is being played, the application software mirrors what the participants are seeing in the playing area. On the top of the screen, menu items “File” 1101, “Start” 1102 and “Options” 1103 are the access points to control the program and the game's operation.

Screen 1100 is the main display of the computer program and reflects the current state and score of the game as seen on system scoreboard 400. The number of targets and specific target layout, viewing distances, lighting conditions, etc. drives the scoreboard 400 that is used. The representation on this screen will be modified to reflect the specific display. The scoreboard 400 will have the minimum elements: a timer 1132, a text banner 1131, target icons 1110-1118 and corresponding numeric counters 1120-1128. The display banner text is controlled and edited from 1301-1307 (FIG. 13). The number of target icons and corresponding numeric counters are examples and not limitation. Game logic 500 (see FIG. 5) updates time clock 1132 and numeric counters 1120-1128. In parallel, game logic 500 sends control signals 403 to the scoreboard 400, updating as required.

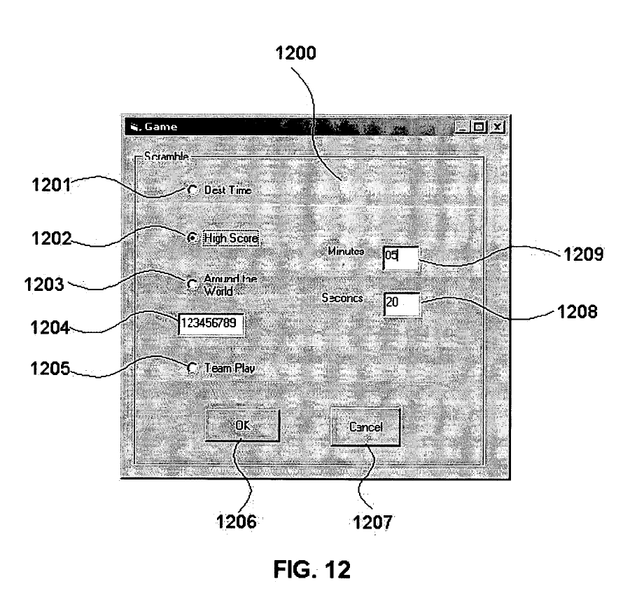

To ensure ease of learning and use by range personnel, game program 500 of FIG. 5 runs on a standard consumer type computer and under the most popular desktop operating system. This is offered by way of example and not limitation. In another embodiment, game program 500 could be run on custom computer. Rather than being confronted by a screen full of text and data entry boxes, the operator is presented with a mirror image of what the patrons on the range are actually seeing. At any moment the operator can see the exact state of the game on the computer screen. Therefore, as is often the case, a solitary employee can man the counter in the clubhouse while at the same time monitoring the game in progress. The following figures (FIGS. 12 and 13) show how easy it is to control the system in real time. It is also possible to schedule all the functions of the system in advance. Thus, a full day's, or even a week's, worth of information concerning which game is to be played when, for how long and with what prompts, can be entered in advance and then run automatically.

### FIG. 12

FIG. 12 is a screen graphic of the “Games” dialog box 1200. This dialog box is exposed via a choice under the “Options” menu 1103 (see FIG. 11). In this dialog box, the administrator can choose the game and time duration of the game to be played by the participants. For instance, the selection of “Best Time” 1201 initiates a game requiring the participants to hit each target at least once within the allotted time period. If this is accomplished, player time is compared with the best previous time recorded to determine which group of players ultimately is declared the winner. The selection of “High Score” 1202 initiates a game requiring the participants to score as many points as possible within the allotted time period. Points are awarded for each target hit. When time runs out their score is compared with the best previous score recorded to determine which group of players ultimately is declared the winner. The selection of “Around the World” 1203 initiates a game requiring the participants to hit each target in a specified and successive order. Therefore, striking a target out of turn does not register as a strike. The scoreboard is used to indicate, at any given time, which target must be hit. When all targets have been hit in the requisite order, the length of time it took to complete the task for the current participants is compared with the best previous time recorded to determine which group of players ultimately is declared the winner. Data entry box 1204 gives the administrator the opportunity to program the order in which the targets must be hit. The selection of “Team Play” 1205 initiates a game where groups of targets are assigned to groups (or teams) of participants. Each group of participants tries to score as many points as possible by hitting their assigned targets within the allotted time period. When time runs out the winner is the team having the most points. This embodiment teaches four games by way of example and not limitation.

Dialog box 1200 has data entry boxes “Minutes” 1209 and “Seconds” 1208 that gives the administrator the opportunity to set the duration of any selected game. “OK” button 1206 closes the dialog box setting the program with the selected parameters. The “Cancel” button 1207 closes the dialog box without resetting the program's parameters.

One of the great strengths of this system from a business perspective is its ability to provide player entertainment without requiring the knowledge of which player hit the ball. This aspect of the system is what makes it affordable. Because of this, the games themselves are a critical aspect of the system. The development of entertainments that can be enjoyed without tracking each ball to a given player, is part of what makes this system both unique and valuable as compared to prior art. This figure demonstrates just a few of the games developed for use with this system. Many more games as well as countless variations on the games taught above are possible. Another strength of the system from a business perspective is that everything relating to the nature of the games encourages more business for the range owner. First, the fact that all the games are played in a group format, many being designed so that the more players the better chance of winning, completely changes the dynamic of range patronage. Practice, which was previously the only reason people attended a driving range, is a solitary act. Compare that to the idea of going to a range to play the games taught above. With the interactive system provided by the present invention, people will look forward to the opportunity to bring others with them to the range. Thus transforming practicing at the driving range into a social event.

Second, the fact that all the games taught are played with a time factor encourages patrons to hit balls more quickly. Golf ranges make their money by patrons buying balls to hit. In the course of playing these games, patrons are likely to hit the same number of balls in a fraction of the time they would take in an actual practice session. Moreover, when they are done playing one game, another is due to start.

Another strength of the games taught herein, which helps to encourage more business for the range owner, is that players are not only competing in the current game but also for the best score for a given time period. For example, a group responsible for producing a high score for a given week can be eligible for a grand prize. Therefore players are encouraged to come back, and bring more family and friends in the hopes of qualifying for the larger prize.

Most importantly, in addition to the general draw these games have on potential customers, their existence enables the range owner to schedule events around the playing of the games rather than relying solely on the players who come to practice their skills in the traditional manner. This gives the range owner the ability to attract people to their facilities at specific times. In the past, golfers came whenever they felt like practicing and the range owner would just sit and wait for them to show up, now players will come to participate in an event the range owner has purposefully scheduled. This makes the business model for a driving range similar to that of league play and tournaments at a bowling alley.

Another very significant benefit of this system is its appeal to a wider audience. Without the system and the games that are part of it, only those with the desire and discipline to learn and practice a difficult game, e.g., golf, would frequent a driving range. Now, with the advent of an entertainment system that requires less time and money to play and does not carry with it much of the stress felt by novice players on a golf course, many more novice golfers would frequent the range as well.

### FIG. 13

FIG. 13 is a screen graphic of the “Prompts” dialog box 1300. This dialog box is exposed via a choice under the “Options” menu 1103 (see FIG. 11). In this dialog box, the administrator can edit the text displayed at various times throughout the operation of the system.

Text box titled “Timed Prompt” 1301 allows the administrator to specify the text displayed on scoreboard 400 and banner line 401 (FIG. 4) just prior to, and during the “Best Time” game. Text box titled “High Score Prompt” 1302 and Text box titled “Around the World Prompt” 1303 allows the administrator to specify the text displayed on scoreboard 400 banner line 401 just prior to, and during the “High Score” game and the “Around the World” game respectfully. Remaining text box's 1304, 1305, 1306, and 1307 are treated the same way as the text boxes previously mentioned. Each text box displays an appropriate message for the intended purpose of the box.

The “OK” button 1308 closes the dialog box setting the program to display the specified prompts. The “Cancel” button 1309 closes the dialog box without resetting the specified prompts.

This simple text dialog box permits the operator to rapidly customize messages to players to meet current needs. For instance, the operator can easily provide instructions as to how to play any current game by simply typing in and saving the game instructions. The current invention permits a variety of games to be played with no physical change to the setup, only a change in computer program settings. These text messages provide the necessary information to the players in order to instruct and play the various games. Handling the text messages in this fashion makes it simple for the operator to customize the communications with the players to meet the needs of the situation. For example, messages for a special corporate event can be customized for a specific company and or departments within that company. For league play, team names can be easily added. This is particularly useful because the system itself can be moved to a variety of locations.

### Summary of Benefits and Improvements

The current invention provides off-course entertainment for golfers while promoting skills development by transforming golf practice into play. By doing so the present invention increases revenues for range operators by facilitating game play and competition at their facilities. The system provides for ongoing entertainment as well as enabling range operators to host league play, corporate outings and other special events. Most importantly, unlike much of the prior art, the present invention is affordable to a majority of range owners. This affordability is due to the systems relative simplicity and minimal maintenance requirements.

One key to the systems affordability is that it does not require determining which player hits which ball. While individuals can use the system to compete with each other on a one on one basis, the present invention is designed primarily to support group play rather than individual play. Therefore, the core features of this system are: the ability to acoustically detect an object striking a target; provide games featuring group play and scoring; provide a time clock to play against and a common scoreboard rather than individual displays. In addition to making the system affordable, these features also make the system flexible (from a configuration standpoint) and portable.

Another benefit of the present invention is that its features are designed to support the creation of increased revenue for range owners by encouraging players to bring friends with them and to hit more balls in a shorter period of time. This is supported by the system's games, which are designed to encourage group play, as well as the time dimension of the games enabled by the game clock, and the system's automated scoring functions.

Another benefit of the present invention is its adaptability to different targets of virtually any size and shape made from a variety of materials. For example. by simply changing the sensor mechanism, the system can be modified to work using inflatable targets rather than a rigid panel.

Other benefits of the present invention include ease of implementation. Design features such as the long battery life (approximately 1 year) of the strike detector resulting from its low power requirements, the shared scoreboard, and flexible target design make the system easily installable at virtually any golf driving range.

Another benefit of the present invention is its ability to support a multi-section target with individual sensors and a common strike detector. The target may consist of sub-targets, for example, a bull's eye of concentric rings with varying point values assigned to each. This feature of the present invention permits the installation of additional targets, which may also include targets having more target complexity, with very little cost increase.

Another benefit is the measurement of the relative impact force. The impact force is proportional to the object speed. This measurement along with other parameters, such as a time stamp, is sent in a coded message. This feature permits the discrimination of multiple bounces from two nearly simultaneous strikes. Measuring the impact force (estimate of relative speed) combined with the spatial target location permits differentiation between for example a home run and a double when targets (FIG. 10) are hit.

The strike detector processor determines the amplitude and acoustic signature of the target strike, thereby eliminating erroneous double bounce or false signals. The strike detector will work with a variety of low cost dynamic microphone/vibration sensors. The strike amplitude, which is measured with an unique target number/I, is communicated to game logic and display. The ultra low power strike detector system of the present invention works with any shape of target which may be made from any ridged material, making the system unique. All these features add to the ability of the system to be adapted to games such as hockey, baseball and soccer, just to name a few.

The free form target taught by the present invention permits fun shaped targets of virtually any size to be constructed and implemented with the system. The strike detector supports multiple external sensors for attachment to very large targets to insure strike detection, thus adding opportunities for raising additional advertising revenue.

The wireless link permits the targets to be periodically moved or placed on a moving platform to add a dynamic element and a greater challenge.

Although the present invention has been described with reference to the disclosed embodiments, numerous modifications and variations can be made and still the result will come within the scope of the invention. No limitation with respect to the specific embodiments disclosed herein is intended or should be inferred.

1) A Game System that can be permanent, temporary, or fully portable, which converts golf ranges, practice cages and fields or other sports like arenas into entertaining and/or competitive gaming events, comprising:
a. A computer Game Engine that allows for selection of the game, associated logic, the relationship between time, targets, scores, sound, and display, all of which support the game objectives and purpose;
b. A Sound Interface that will allow the system to enumerate using external speakers the objectives, purpose, and the instructions, both initial and ongoing, of the game, as well as, provide sound effects for target impact when they occur;
c. Targets that have integrated strike detection capable of strike intensity measurements, are power by either low voltage or battery, and will repel the balls on impact, and in turn communicate that impact information to the Game Engine; and
d. Connection or connections between the various elements of the system for the passing of information, that may consist of any communication medium RS-232, RS485, Ethernet, Bluetooth, or other wireless or wired communications.

2) A Game Engine as in claim #1 which can be freestanding or embedded into any one of the other system elements, comprising:
a. a CPU motherboard,
b. a video interface for office console display when applicable,
c. a sound module or card for creation of sound effects and verbal instructions provided through external speakers upon target impact,
d. a storage device,
e. memory,
f. communications transceiver or transceivers for wired or wireless communications to the other elements of the system; and
g. with all tasks provided under software or firmware control, with or without the use of a standard operating system.

3) A Game System as in any one of the proceeding claims with a Scoreboard or other mass display devices that will allow the Game Engine to communicate visually with the players such information as the game state, status and instructions, messages, target information or impact, scores, and any other active information; said device may take whatever form is required by the customer and may include such display extras that would normally be associated with baseball, football, hockey and basketball game displays.

4) A Game System as in any one of the proceeding claims with multiple Scoreboards as described in claim #3 that when used in multiple display configurations will display information that includes the competitive scores of the teams, in addition to the team or player oriented information described in claim #3.

5) A Game System as in any one of the proceeding claims that when used on Golf Driving Ranges changing of the experience from practice to play and will enable the range owners to promote game play, with a majority of these games played by all the customers on the range functioning as one team, therefore requiring time as a critical element and for the scoring of these games to be strictly group or team without the need to distinguish which player hit which ball and the expense thereof.

6) A Game System as in any one of claims #1-4 that will be used in Batting Cages which will use multiple targets to represent different types of hits (singles, doubles, triples, etc), outs and foul balls, thus enabling the batter to actually play a game of baseball where the scoreboard will track the progress of that game; said progress would include time and impact intensity as the main elements of the game, as a target hit with a recorded intensity above a certain level counts as a base hit while a hit of the same target with less intensity would result in an out.
